(19) United States
(12) Patent Application Publication
(10) Pub. No.: US 2023/0371600 A1
(43) Pub. Date: Nov. 23, 2023

(54) HEATING ASSEMBLY AND ELECTRONIC VAPORIZATION DEVICE

(71) Applicant: SHENZHEN SMOORE TECHNOLOGY LIMITED, Shenzhen (CN)

(72) Inventors: Yinxiang DUAN, Shenzhen (CN); Jinfeng JIANG, Shenzhen (CN); Mingda ZHU, Shenzhen (CN); Peng CHEN, Shenzhen (CN); Jiansheng XIE, Shenzhen (CN); Jing DU, Shenzhen (CN); Guihua BU, Shenzhen (CN); Liangfu ZHENG, Shenzhen (CN); Yuming XIONG, Shenzhen (CN); Zhenxing WU, Shenzhen (CN); Jingbo FAN, Shenzhen (CN)

(21) Appl. No.: 18/361,984

(22) Filed: Jul. 31, 2023

Related U.S. Application Data
(63) Continuation of application No. PCT/CN2021/074920, filed on Feb. 2, 2021.

(51) Int. Cl. A24F 40/46

(52) U.S. Cl. CPC A24F 40/46; A24F 40/51

(57) ABSTRACT

A heating assembly applied to an electronic vaporization device includes: a ceramic substrate; and a heating layer including stainless steel and inorganic non-metal. The heating layer heats a substrate to be vaporized to form an aerosol and has a temperature coefficient of resistance (TCR) temperature-sensitive characteristic. The inorganic non-metal adjusts the TCR of the heating layer.

### CROSS-REFERENCE TO PRIOR APPLICATION

This application is a continuation of International Patent Application No. PCT/CN2021/074920, filed on Feb. 2, 2021. The entire disclosure is hereby incorporated by reference herein.

### FIELD

This application relates to the technical field of vaporizers, and specifically, to a heating assembly and an electronic vaporization device.

### BACKGROUND

On the market, most of ceramic vaporization cores of several electronic vaporization devices with a better taste are printed on a porous ceramic substrate with iron-nickel-chromium or iron-chromium-aluminum. Iron-nickel-chromium or iron-chromium-aluminum has characteristics such as high temperature resistance, good high-temperature stability, high-temperature oxidation resistance, and high solution corrosion resistance.

As the technology of the electronic vaporization device becomes increasingly mature, consumers have a higher requirement on the taste. However, this type of ceramic vaporization core cannot achieve temperature control, and phenomena such as offensive odor, a burnt taste, and poor fragrance reduction may occur during vaporization, affecting user experience.

### SUMMARY

In an embodiment, the present invention provides a heating assembly applied to an electronic vaporization device, the heating assembly comprising: a ceramic substrate; and a heating layer comprising stainless steel and inorganic non-metal, wherein the heating layer is configured to heat a substrate to be vaporized to form an aerosol and has a temperature coefficient of resistance (TCR) temperature-sensitive characteristic, and wherein the inorganic non-metal is configured to adjust the TCR of the heating layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic vaporization device according to this application;

FIG. 2 is a schematic structural diagram of a heating assembly according to this application;

FIG. 3 is a scanning electron microscope image of microscopic morphology of a heating layer of a heating assembly according to this application;

FIG. 4 is a schematic flowchart of a method for manufacturing a heating assembly according to this application; and

FIG. 5 is a diagram of a relationship b between resistance and temperatures of heating assemblies in Experiment 7 according to this application.

### DETAILED DESCRIPTION

In an embodiment, the present invention provides a heating assembly and an electronic vaporization device to solve a technical problem that a metal layer of a ceramic vaporization core cannot realize temperature control in the prior art.

In an embodiment, the present invention provides a heating assembly, including: a ceramic substrate and a heating layer. The heating layer includes stainless steel and inorganic non-metal. The heating layer is configured to heat a substrate to be vaporized to form an aerosol and has a temperature coefficient of resistance (TCR) temperature-sensitive characteristic. The inorganic non-metal is configured to adjust a TCR of the heating layer.

The stainless steel includes one or more of 316L stainless steel, 304 stainless steel, and 430 stainless steel.

The inorganic non-metal includes one or more of SiO₂, Al₂O₃, ZrO₂, and SiC.

Non-stainless steel metal is further included, and the non-stainless steel metal includes one or more of Mo, Ti, Zr, and Mg.

A glass phase is further included, and the glass phase includes one or more of a SiO₂—ZnO—BaO system, a SiO₂—CaO—ZnO system, a SiO₂—ZnO—R₂O system, and a SiO₂—B₂O₃ system.

The heating layer includes the stainless steel, the inorganic non-metallic material, the glass phase, and the non-stainless steel metal. The stainless steel accounts for 75-85% by weight of the heating layer, and the inorganic non-metallic material accounts for 0.5-3% by weight of the heating layer, the glass phase accounts for 11.5-21.5% by weight of the heating layer, and the non-stainless steel metal accounts for 0.5%-3% by weight of the heating layer.

The stainless steel is one or more of 316L stainless steel, 304 stainless steel, and 430 stainless steel. The inorganic non-metal is one or more of SiO₂, Al₂O₃, ZrO₂, and SiC. The non-stainless steel metal is one or more of Mo, Ti, Zr, and Mg. The glass phase is one or more of a SiO₂—ZnO—BaO system, a SiO₂—CaO—ZnO system, a SiO₂—ZnO—R₂O system, and a SiO₂—B₂O₃ system.

The thickness of the heating layer ranges from 100 μm to 120 μm. The resistance of the heating layer ranges from 0.6Ω to 0.8Ω.

In order to solve the above technical problem, the second technical solution provided in this application is to provide an electronic vaporization device, including: a heating assembly, the heating assembly is the heating assembly according to any one described above.

Beneficial effects of this application are as follows: Different from the prior art, the heating assembly in this application includes a ceramic substrate and a heating layer. The heating layer includes stainless steel and inorganic non-metal. The heating layer is configured to heat a substrate to be vaporized to form an aerosol and has a TCR temperature-sensitive characteristic. The inorganic non-metal is configured to adjust a TCR of the heating layer. The heating layer is made of stainless steel, so that the heating assembly has characteristics such as high temperature resistance, good high-temperature stability, high-temperature oxidation resistance, and high solution corrosion resistance. Inorganic non-metallic materials are added to the stainless steel to realize temperature control of the heating layer, thereby avoiding offensive odor and a burnt taste during vaporization, ensuring consistency of fragrance, and improving user experience.

This application is further described in detail below with reference to the accompanying drawings and embodiments. It should be specifically noted that, the following embodiments are only used to illustrate this application, but are not intended to limit the scope of this application. Similarly, the following embodiments are only some rather than all of the embodiments of this application, and all other embodiments obtained by a person of ordinary skill in the art without creative efforts shall fall within the protection scope of this application.

The terms “first”, “second”, and “third” in this application are used for descriptive purposes only, and cannot be construed as indicating or implying relative importance or implicitly indicating a quantity of indicated technical features. Therefore, features defined by “first”, “second”, and “third” may explicitly or implicitly include at least one of the features. In description of this application, “a plurality of” means at least two, such as two or three, unless otherwise explicitly and specifically defined. All directional indications (such as up, down, left, right, front, back . . . ) in the embodiments of this application are only used to explain relative positional relationships, movement situations, or the like between components in a certain posture (as shown in the accompanying drawings). If the specific posture changes, the directional indications also change accordingly. The terms “comprising” and “having” and any variant thereof in the embodiments of this application are intended to cover a non-exclusive inclusion. For example, a process, method, system, product, or device including a series of steps or units is not limited to the listed steps or units, but further optionally includes a step or unit that is not listed, or further optionally includes another step or component that is intrinsic to the process, method, product, or device.

“Embodiment” mentioned herein means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly and implicitly understand that the embodiments described herein may be combined with other embodiments.

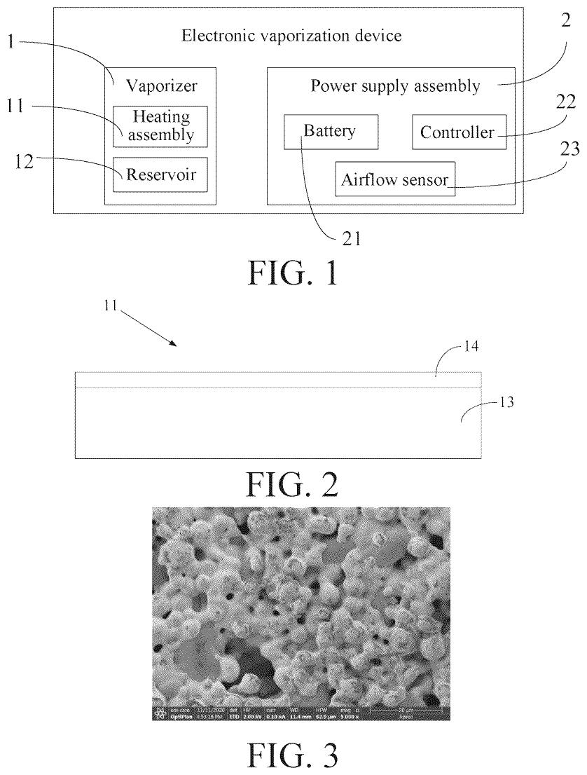

FIG. 1 is a schematic structural diagram of an electronic vaporization device according to this application.

The electronic vaporization device may be configured to vaporize liquid substrates. The electronic vaporization device includes a vaporizer 1 and a power supply assembly 2 connected to each other.

The vaporizer 1 includes a heating assembly 11 and a reservoir 12. The reservoir 12 is configured to store a substrate to be vaporized. The heating assembly 11 is configured to heat and vaporize the substrate to be vaporized in the reservoir to form an aerosol that can be inhaled by a user. The vaporizer 1 may be specifically configured to vaporize the substrate to be vaporized and generate an aerosol for use in different fields such as medical treatment and an electronic aerosol vaporization device. In a specific embodiment, the vaporizer 1 may be applied to the electronic aerosol vaporization device and is configured to vaporize the substrate to be vaporized and generate an aerosol for a smoker to inhale which is taken as an example in the following embodiments. Certainly, in other embodiments, the vaporizer 1 may also be applied to a hair spray device to vaporize hair spray for hair styling. Alternatively, the vaporizer is applied to a medical device for treating upper and lower respiratory system diseases to vaporize medical drugs.

The power supply assembly 2 includes a battery 21, a controller 22, and an airflow sensor 23. The battery 21 is configured to supply power to the vaporizer 1, so that the vaporizer 1 can vaporize a liquid substrate to form an aerosol. The controller 22 is configured to control operation of the vaporizer 1. The airflow sensor 23 is configured to detect an airflow change in the electronic vaporization device, so as to start the electronic vaporization device.

The vaporizer 1 and the power supply assembly 2 may be integrally arranged or detachably connected, which is designed according to specific needs.

FIG. 2 is a schematic structural diagram of a heating assembly according to this application.

The heating assembly 11 includes a ceramic substrate 13 and a heating layer 14. The ceramic substrate 13 is a porous ceramic, and the ceramic substrate 13 contacts the substrate to be vaporized in the reservoir 12, and guides it to the heating layer 14 by capillary force, and the heating layer 14 heats and vaporizes it to form an aerosol. The heating layer 14 includes stainless steel and inorganic non-metal. The heating layer 14 is configured to heat and vaporize the substrate to be vaporized to form an aerosol and has a TCR (temperature coefficient of resistance) temperature-sensitive characteristic. The inorganic non-metal is configured to adjust a TCR of the heating layer 14. That is to say, the heating layer 14 in this embodiment is made of stainless steel, so that the heating layer 14 has the TCR temperature-sensitive characteristic, and the heating assembly 11 has the characteristics such as high temperature resistance, good high-temperature stability, high-temperature oxidation resistance, and solution corrosion resistance of an existing ceramic vaporization core. Further, inorganic non-metallic materials are added to the heating layer 14 to adjust the TCR (temperature coefficient of resistance) value of the heating layer 14, which can realize temperature sensing and control of the heating layer 14, thereby avoiding offensive odor and a burnt smell during vaporization, improving a heat flux density and temperature field uniformity of the heating assembly 11, improving consistency of fragrance, and improving user experience.

The stainless steel includes one or more of 316L stainless steel, 304 stainless steel, and 430 stainless steel, or may be stainless steel of another grade. A maximum temperature of heating and vaporizing an e-liquid is preferably controlled below 350 degrees. However, if a temperature coefficient of resistance (TCR) of a general stainless steel heating film is too high, a temperature of the heating film easily exceeds 350 degrees. This problem can be solved by adding inorganic non-metallic materials in this application. The inorganic non-metallic material includes one or more of SiO₂, Al₂O₃, ZrO₂, and SiC, or may be another inorganic non-metallic material. By adding a small amount of inorganic non-metallic materials in the heating layer 14, the resistance, the temperature coefficient of resistance, and the corrosion resistance of the heating layer 14 can be adjusted. The stainless steel and inorganic non-metallic materials in the heating layer 14 may be selected according to needs, as long as the temperature of the heating assembly 11 can be controlled. For example, the heating layer 14 includes stainless steel and inorganic non-metal, and the inorganic non-metal accounts for 1% of a total weight of the heating layer 14.

Further, the heating layer 14 further includes non-stainless steel metal. The non-stainless steel metal includes one or more of Mo, Ti, Zr, and Mg. By adding a small amount of metal such as Mo, Ti, Zr, and Mg in the heating layer 14, compactness and uniformity of the heating layer 14 are good, which is beneficial to improving the corrosion resistance, high-temperature resistance, and a service life of the heating layer 14, and enhancing a bonding force between the heating layer 14 and the ceramic substrate 13, thereby greatly improving electrochemical stability of the heating layer 14 in an operating environment of the electronic vaporization device. For example, the heating layer 14 includes stainless steel, non-stainless steel metal and inorganic non-metallic materials, the inorganic non-metal accounts for 1% of the total weight of the heating layer 14, and the non-stainless steel metal accounts for 0.5% of the total weight of the heating layer 14.

Currently, most of heating layers in conventional heating assemblies are heating layers of iron-nickel-chromium or iron-chromium-aluminum printed on porous ceramic substrates. However, heavy metal ions (such as nickel and chromium) may be detected in a substrate to be vaporized and aerosol components of an electronic vaporization device using such an alloy heating layer. It may be understood that, in this application, the electrochemical stability of the heating layer 14 in the operating environment of the electronic vaporization device is improved by adding a small amount of metal such as Mo, Ti, Zr, and Mg in the heating layer 14, so that heavy metal content in the substrate to be vaporized and the aerosol is greatly reduced, and the key problem of potential safety hazards caused by existing heating assemblies to users can be solved.

In this application, the heating layer 14 is made by drying a resistance paste. The resistance paste includes stainless steel powder, non-stainless steel metal, inorganic non-metal, a glass phase, and an organic carrier. The organic carrier includes resins and solvents. In the drying process of the resistance paste, the organic carrier continues to volatilize. Therefore, the heating layer 14 includes stainless steel powder, non-stainless steel metal, inorganic non-metal, and glass phase. A difference between the heating layer 14 and an electronic paste lies in whether an organic carrier is included or not. By adding the glass phase in the heating layer 14, matching between the stainless steel and the ceramic substrate 13 is enhanced, sintering stability of the stainless steel heating layer 14 is improved, and a sintering problem of the stainless steel heating layer 14 is solved.

Among them, the stainless steel powder accounts for 60%-76.5% of the total weight of the resistance paste, the glass phase accounts for 9.2%-17.2% of the total weight of the resistance paste, the inorganic non-metal accounts for 0.4%-2.7% of the total weight of the resistance paste, the non-stainless steel metal accounts for 0.4%-2.7% of the total weight of the resistance paste, and the organic carrier accounts for 10%-20% of the total weight of the resistance paste.

The glass phase is a SiO₂—ZnO—BaO system. The glass phase system can better match the ceramic substrate 13, to prevent the resistance paste from and damaging the ceramic substrate 13 or causing microcracks on the heating layer 14 due to stress generated in a high-temperature sintering process. The glass phase system is not limited to the SiO₂—ZnO—BaO system, or another system such as SiO₂—CaO—ZnO, SiO₂—ZnO—R₂O, SiO₂—B₂O₃, which can be selected according to the sintering process of the ceramic substrate 13 and the resistance paste.

The organic carrier includes resins and solvents. The resin includes ethyl cellulose, and the solvent includes terpineol and butyl carbitol acetate systems. Both terpineol and butyl carbitol acetate are good solvents for ethyl cellulose, and a combination of terpineol and butyl carbitol acetate can control volatility and leveling of the resistance paste. In addition, terpineol and butyl carbitol acetate can adjust viscosity of the organic carrier, and proper viscosity can fully wet metal and inorganic non-metallic materials, thereby improving printability of the resistance paste. Ethyl cellulose accounts for 3%-8% of a total weight of the organic carrier, terpineol accounts for 50%-70% of the total weight of the organic carrier, and butyl carbitol acetate accounts for 27%-42% of the total weight of the organic carrier. In other embodiments, the resin may also be cellulose acetate butyrate, acrylic resin, polyvinyl butyral, or the like. The solvent may also be butyl carbitol, diethylene glycol dibutyl ether, triethylene glycol butyl ether, alcohol ester dodeca, tributyl citrate, tripropylene glycol butyl ether, or the like. A specific material composition of the resin and solvent may be selected according to needs.

In the heating layer 14 made by drying the resistance paste, the stainless steel accounts for 75%-85% of the total weight of the heating layer 14, the glass phase accounts for 11.5%-21.5% of the total weight of the heating layer 14, the inorganic non-metal accounts for 0.5%-3% of the total weight of the heating layer 14, and the non-stainless steel metal accounts for 0.5%-3% of the total weight of the heating layer 14.

FIG. 3 is a scanning electron microscope image of microscopic morphology of a heating layer of a heating assembly according to this application.

In this application, a screen used for the resistance paste has 200 mesh, a yarn thickness of 80 μm, an emulsion thickness of 100 μm, and a line width of 0.5 mm for printing. The heating layer 14 is obtained after drying and sintering. The microscopic morphology is shown in FIG. 3. The thickness of the heating layer 14 ranges from 100 μm to 200 μm, and the resistance ranges from 0.6Ω to 0.8Ω. In other embodiments, spraying, physical vapor deposition (PVD), chemical vapor deposition (CVD), and other processes can also be used to manufacture the heating layer 14, and a specific process can be selected according to needs.

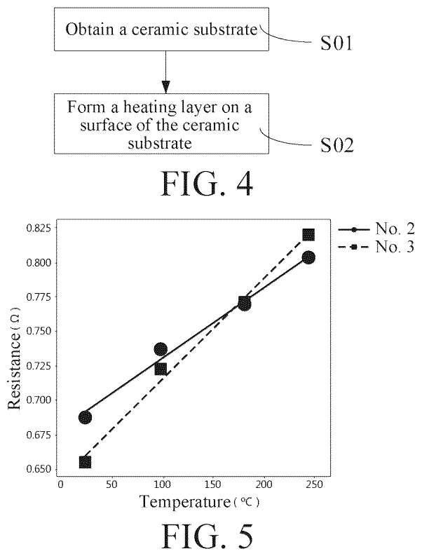

FIG. 4 is a schematic flowchart of a method for manufacturing a heating assembly according to this application. The method for manufacturing the heating assembly 11 includes the following steps:

S01: Obtain a ceramic substrate.

Specifically, ceramic powder is prepared, and the ceramic substrate 13 is made in a process such as screen printing or sintering.

S02: Form a heating layer on a surface of the ceramic substrate.

Specifically, a raw material used to form the heating layer 14 are made into a resistance paste, the resistance paste is screen-printed on the surface of the porous ceramic substrate 13, and the ceramic substrate 13 and the resistance paste are dried and sintered at 1000-1250° C. to form the heating layer 14 on the surface of the ceramic substrate 13.

In an embodiment, in the resistance paste, the stainless steel powder accounts for 75% of the total weight of the resistance paste, the glass phase accounts for 12% of the total weight of the resistance paste, the inorganic non-metal accounts for 1% of the total weight of the resistance paste, the non-stainless steel metal accounts for 0.5% of the total weight of the resistance paste, and the organic carrier accounts for 11.5% of the total weight of the resistance paste. In the organic carrier, the resin accounts for 5% of the total weight of the organic carrier, and the solvent accounts for 95% of the total weight of the organic carrier. The thickness of the heating layer 14 is 100 and the resistance is 0.6Ω.

The stainless steel powder adopts 361L stainless steel powder, the glass phase adopts a SiO₂—ZnO—BaO system, the inorganic non-metal adopts SiO₂, the non-stainless steel metal adopts Mo and Mg, the resin in the organic carrier adopts ethyl cellulose, and the solvent adopts terpineol and butyl carbitol acetate systems. Ethyl cellulose accounts for 5% of the total weight of the organic carrier, terpineol accounts for 60% of the total weight of the organic carrier, and butyl carbitol acetate accounts for 35% of the total weight of the organic carrier.

It may be understood that pins need to be arranged on the heating layer 14 of the heating assembly 11 to be electrically connected to the battery 21, and the pins are coated with silver paste to prevent the pins from being corroded by a substrate to be vaporized or a vaporized aerosol, to play a role of protecting. Another metal coating may also be selected, according to needs, to protect the pins.

The heating assembly 11 provided in this application is compared with the existing heating assembly No. 1, and the performance is proved through experiments. The heating assembly 11 provided in this application for the experiment includes stainless steel, non-stainless steel metal, a glass phase, and inorganic non-metal. The stainless steel adopts 361L stainless steel powder, the glass phase adopts a SiO₂—ZnO—BaO system, the inorganic non-metal adopts SiC, and the non-stainless steel metal adopts Mo or Mg. The stainless steel accounts for 75% by weight of the heating layer, the inorganic non-metallic material accounts for 1% by weight of the heating layer, the glass phase accounts for 12% by weight of the heating layer, and the non-stainless steel metal accounts for 0.5% by weight of the heating layer. The main component of a heating layer in an existing heating assembly No. 1 is nickel-chromium (T29) with a nickel-chromium content of 85.6% and a glass phase content of 14.4%. For the convenience of statistics, the heating assembly 11 provided in this application is recorded as a heating assembly No. 2.

### Experiment 1: Test for Service Life in Dry Combustion Cycle

Experimental conditions: Constant power of 6.5 W, on for 3S and off for 8S, and a cycle of 50 times.

The heating assembly 11 provided in this application and an existing heating assembly No. 1 were tested under the above experimental conditions to determine a resistance change and whether the resistance change is invalid. In order to ensure accuracy of experimental results, three parallel experiments were performed on the heating assembly 11 in this application and the existing heating assembly No. 1. The experimental results are shown in Table 1.

TABLE 1
Test for service life of 316L
stainless steel heating layer in dry combustion

| Heating | Quantity of | Invalid | Resistance | Test |
|---|---|---|---|---|
| assembly | cycles/time | or not | change | environment |
| No. 1 | 10 | Yes | Invalid | Air |
| No. 1 | 13 | Yes | Invalid | Air |
| No. 1 | 11 | Yes | Invalid | Air |
| No. 2 | 50 | No | No change | Air |
| No. 2 | 50 | No | 0.02 Ω | Air |
| No. 2 | 50 | No | 0.01 Ω | Air |

### Experiment 2: Test for Service Life in Wet Combustion Cycle

Experimental conditions: Constant power of 6.5 W, on for 3S and off for 8S, and a cycle of 400 times.

The heating assembly 11 provided in this application and the existing heating assembly No. 1 were tested under the above experimental conditions to determine a resistance change and whether the resistance change is invalid. In order to ensure the accuracy of the experimental results, three parallel experiments were performed on the heating assembly 11 in this application and the existing heating assembly No. 1. Experimental results are shown in Table 2.

TABLE 2
Test for service life of 316L stainless
steel heating layer in wet combustion

| Heating | Quantity of | Break | | Test |
|---|---|---|---|---|
| assembly | cycles/time | or not | Resistance change | environment |
| No. 1 | 400 | No break | No change, but the | Glycerol |
| | | | surface turns black | |
| No. 1 | 400 | No break | No change, but the | Glycerol |
| | | | surface turns black | |
| No. 1 | 400 | No break | No change, but the | Glycerol |
| | | | surface turns black | |
| No. 2 | 400 | No break | No change, and no | Glycerol |
| | | | blackening | |
| No. 2 | 400 | No break | No change, and no | Glycerol |
| | | | blackening | |
| No. 2 | 400 | No break | No change, and no | Glycerol |
| | | | blackening | |

### Experiment 3: Metal Dissolution Test in 4% Acetic Acid

Experimental conditions: Soak in 4% acetic acid.

The heating assembly 11 provided in this application and the existing heating assembly No. 1 were tested under the above experimental conditions, and amounts of metal dissolution were compared. Experimental results are shown in Table 3.

TABLE 3
4% acetic acid soaking results

| Heating | Amount of leached | Amount of leached |
|---|---|---|
| assembly | Ni (g/ml) | Cr (g/ml) |
| No. 1 | 16.2 | 1.1 |
| No. 2 | 0.093 | 0.033 |

### Experiment 4: Metal Dissolution Test in Mango E-Liquid of 57 Mg

Experimental conditions: Soak in mango e-liquid of 57 mg.

The heating assembly 11 provided in this application and the existing heating assembly No. 1 were tested under the above experimental conditions, and amounts of metal dissolution were compared. Experimental results are shown in Table 4.

TABLE 4
Soaking results of mango e-liquid of 57 mg

| Heating | Amount of leached | Amount of leached |
|---|---|---|
| assembly | Ni (g/ml) | Cr (g/ml) |
| No. 1 | 3.0 | 1.0 |
| No. 2 | 0.08 | 0.03 |

### Experiment 5: Heavy Metal Content in Flue Gas

Experimental conditions: Mango e-liquid of 57 mg, constant power of 6.5 W, inhaling for 3S and stopping for 8S, and inhalation of 100 puffs.

The heating assembly 11 provided in this application and the existing heating assembly No. 1 were tested under the above experimental conditions, and heavy metal contents in the flue gas were compared. Experimental results are shown in Table 5.

TABLE 5
Heavy metal content in flue gas

| Heating | Ni content in flue gas | Cr content in flue gas |
|---|---|---|
| assembly | (g/100 puffs) | (g/100 puffs) |
| No. 1 | 2.542 | 0.138 |
| No. 2 | Not detected | Not detected |

### Experiment 6: Film-Base Binding Force

A bonding force between the heating layer 14 and the ceramic substrate 13 in the heating assembly 11 provided in this application and a bonding force between a heating layer and a ceramic substrate in the existing heating assembly No. 1 were tested, and film-base bonding forces were compared. Experimental results are shown in Table 6.

TABLE 6
Film-base binding force test results

| Heating assembly | Thrust value/gf |
|---|---|
| No. 1 | 1700 |
| No. 2 | 2100 |

### EXPERIMENT 7: Test for Temperature Coefficient of Resistance

Temperature coefficients of resistance (TCR) of heating layers and ceramic substrates in the heating assembly 11 provided in this application, the existing heating assembly No. 1, and an existing heating assembly No. 3 were tested. The main component of the heating layer of the heating assembly No. 3 is stainless steel. A relationship between resistance and temperatures of the heating assembly No. 2 and the heating assembly No. 3 is shown in FIG. 5 (FIG. 5 shows a relationship between resistance and temperatures of heating assemblies in Experiment 7 according to this application). Calculation results are shown in Table 7.

TABLE 7
Temperature coefficient of resistance (TCR)

| Heating assembly | TCR (ppm/° C.) |
|---|---|
| No. 1 | / |
| No. 2 | 726 |
| No. 3 | 1067 |

As can be seen from the experimental results in Table 1 and Table 2, a service life of the heating assembly 11 (heating assembly No. 2) provided in this application is longer than that of the existing heating assembly No. 1. As can be seen from the experimental results in Table 3, Table 4, and Table 5, metal ion dissolution of the heating assembly 11 (heating assembly No. 2) provided in this application is two orders of magnitude lower than that of the existing heating assembly No. 1, and heavy metal cannot be detected in flue gas. Therefore, the heating assembly 11 provided in this application can significantly reduce potential safety hazards caused by the material of the heating layer 14 to the user. As can be seen from the experimental results in Table 6, a film-base bonding force of the heating assembly 11 provided in this application (heating assembly No. 2) is higher than that of the existing heating assembly No. 1, which indicates that the heating assembly 11 has better physical shock resistance. As can be seen from the experimental results in Table 7, compared with the existing heating assembly No. 1, the heating assembly 11 (heating assembly No. 2) provided in this application has TCR performance and can realize temperature control of the heating layer 14 thereof, thereby reducing offensive odor and a burnt taste. In addition, by adding inorganic non-metal, the TCR of the heating layer 14 can be effectively changed, the service life of the heating assembly 11 is prolonged, the heat flux density and temperature field uniformity of the heating layer 14 are improved, and taste consistency and user experience are improved.

The heating assembly in this application includes a ceramic substrate and a heating layer. The heating layer includes stainless steel and inorganic non-metallic materials. The heating layer is configured to heat a substrate to be vaporized to form an aerosol, and has a TCR temperature-sensitive characteristic. The inorganic non-metal is configured to adjust a TCR of the heating layer. The heating layer is made of stainless steel, so that the heating assembly has characteristics such as high temperature resistance, good high-temperature stability, high-temperature oxidation resistance, and high solution corrosion resistance. Inorganic non-metallic materials are added to the stainless steel to realize temperature control of the heating layer, thereby avoiding offensive odor and a burnt taste during vaporization, ensuring consistency of fragrance, and improving user experience.

The above descriptions are only some embodiments of this application, and the protection scope of this application is not limited thereto. All equivalent apparatus or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly applied to an electronic vaporization device, the heating assembly comprising:
a ceramic substrate; and
a heating layer comprising stainless steel and inorganic non-metal,
wherein the heating layer is configured to heat a substrate to be vaporized to form an aerosol and has a temperature coefficient of resistance (TCR) temperature-sensitive characteristic, and
wherein the inorganic non-metal is configured to adjust the TCR of the heating layer.

2. The heating assembly of claim 1, wherein the stainless steel comprises one or more of 316L stainless steel, 304 stainless steel, and 430 stainless steel.

3. The heating assembly of claim 1, wherein the inorganic non-metal comprises one or more of SiO₂, Al₂O₃, ZrO₂, and SiC.

4. The heating assembly of claim 1, further comprising:
non-stainless steel metal,
wherein the non-stainless steel metal comprises one or more of Mo, Ti, Zr, and Mg.

5. The heating assembly of claim 4, further comprising:
a glass phase,
wherein the glass phase comprises one or more of a SiO₂—ZnO—BaO system, a SiO₂—CaO—ZnO system, a SiO₂—ZnO—R₂O system, and a SiO₂—B₂O₃ system.

6. The heating assembly of claim 5, wherein the heating layer comprises the stainless steel, the inorganic non-metallic material, the glass phase, and the non-stainless steel metal, and wherein the stainless steel accounts for 75-85% by weight of the heating layer, the inorganic non-metallic material accounts for 0.5-3% by weight of the heating layer, the glass phase accounts for 11.5-21.5% by weight of the heating layer, and the non-stainless steel metal accounts for 0.5-3% by weight of the heating layer.

7. The heating assembly of claim 6, wherein the stainless steel comprises one or more of 316L stainless steel, 304 stainless steel, and 430 stainless steel,
wherein the inorganic non-metal comprises one or more of SiO₂, Al₂O₃, ZrO₂ and SiC,
wherein the non-stainless steel metal comprises one or more of Mo, Ti, Zr, and Mg, and
wherein the glass phase comprises one or more of the SiO₂—ZnO—BaO system, the SiO₂—CaO—ZnO system, the SiO₂—ZnO—R₂O system, and the SiO₂—B₂O₃ system.

8. The heating assembly of claim 1, wherein a thickness of the heating layer ranges from 100 μm to 120 μm.

9. The heating assembly of claim 1, wherein a resistance of the heating layer ranges from 0.6Ω to 0.8 Ω.

10. An electronic vaporization device, comprising:
the heating assembly of claim 1.
